(19) United States
(12) Patent Application Publication
(10) Pub. No.: US 2020/0273122 A1
(43) Pub. Date: Aug. 27, 2020

(54) SYSTEM AND METHOD FOR PROVIDING AUTOMATED SOCIAL CONTRACTS FOR SHARED REAL ESTATE ENVIRONMENTS

(71) Applicant: Social Equity Incorporated, Sheridan, WY (US)

(72) Inventor: Peter Dwight Sahagen, Sheridan, WY (US)

(73) Assignee: Social Equity Incorporated, Sheridan, WY (US)

(21) Appl. No.: 16/283,400

(22) Filed: Feb. 22, 2019

(51) Int. Cl. G06Q 50/16; G06F 16/22

(52) U.S. Cl. CPC G06Q 50/163; G06F 16/22

(57) ABSTRACT

The present disclosure relates to methods and systems for providing automated social contracts. More specifically embodiments of the present invention are directed to a computerized system and method for providing users of the system to enter into automated self-effecting contracts. Preferred embodiments of the present invention are directed to providing self-effecting social contracts for the management and maintenance of arrangements between individuals sharing a single real estate unit.

### FIELD OF INVENTION

The present disclosure relates to methods and systems for providing automated social contracts. More specifically embodiments of the present invention are directed to a computerized system and method for providing users of the system to enter into automated self-effecting contracts. Preferred embodiments of the present invention are directed to providing self-effecting social contracts for the management and maintenance of arrangements between individuals sharing a single real estate unit.

### BACKGROUND

Due to the ever-increasing cost of real estate, more and more individuals are being excluded from the possibility of owning real estate, at least until later period in life than have been prevalent in the past. Especially in urban and prime sub-urban locations, ownership of a home or apartment is largely out of the question for most young individuals, disadvantaged (e.g., socially, economically, disabled) individuals, and even many older individuals in lower to middle wage-earning demographics.

Instead, these various groups of individuals that do not own real estate and currently have no viable means to obtain real estate, turn to renting residences, often for many years or decades. Unlike ownership in a home, where equity is built over time, rental units require a tenant to simply pay money for the residence without any gained equity in the residence. Accumulating and ever increasing rental cost, coupled with diminishing rental unit housing supply, can be debilitating for individuals worldwide, both financially and with respect to the mobility of such individuals.

Another common practice in high density population areas, like urban and sub-urban areas, is for these groups of individuals to enter into leases for rental properties with other individuals, whereby the individuals share a single rental unit. Commonly referred to in various locations as roommates, flatmates or housemates, these joint living situations are especially common among younger individuals who may not have the affluence to afford the down payments required for real estate ownership outright. As the cost of real estate continues to outpace real wage increases, this practice will be come even more common, and for longer periods of an individual's life.

Given that these individuals that are collectively renting real estate units together are frequently entering into relatively long-term agreements (e.g., >=1 year), and that the individuals may have never lived together before, many times misunderstandings and disagreements arise. These can come about because the individuals did not know each other well, or the ideas they have about how to maintain and utilize living space vary significantly.

These disagreements can leave individuals in living situations where there is not only a negative living environment created, but also no easy way out of said living environment. Individuals are faced with the options of staying in an undesirable living situation or breaking a legal agreement (e.g., lease) to get out.

Therefore, there is a need in the art for systems and methods for providing automatic self-effecting social contracts that are capable of defining and policing maintenance and utilization of living space in a real estate unit in a manner that overcomes the limitations described above.

### SUMMARY OF INVENTION

Accordingly, the subject matter described herein provides systems, methods, and computer-readable non-transitory storage mediums for providing automated real estate ownership mobility.

According to an embodiment of the present invention, a computerized method for providing automated social contracts, said computerized method using a social equity module, a processor and a communication means, the method comprising the steps of: receiving a social contract generation request; identifying one or more users associated with said social contract generation request; identifying a first set of social contract parameters from said social contract generation request; identifying a second set of social contract parameters from said one or more users; determining compatibility between said first set of social contract parameters and said second set of social contract parameters; generating a final set of social contract parameters, wherein said final set of social contract parameters are based at least in part on said first set of social contract parameters and said second set of social contract parameters; determining one or more trigger events for one or more social contract parameters in said final set of social contract parameters, wherein said trigger events generate social contract, wherein said social contract; and generating a social contract based at least in part on said final set of contract parameters and said one or more trigger events.

According to an embodiment of the present invention, the method further comprises the steps of: transmitting said social contract to said one or more users; receiving, from said users, an executed version of said social contract; and recording said social contract.

According to an embodiment of the present invention, the social contract is recorded using a distributed ledger technology.

According to an embodiment of the present invention, the method further comprises the steps of: receiving a trigger alert associated with said social contract; identifying a trigger event from said one or more trigger events, wherein said trigger event is associated with said trigger alert; and executing a social equity action in response to said trigger event.

According to an embodiment of the present invention, the social equity action is selected from the group comprising financial transactions, termination in ownership of a real estate unit, change in equity in a real estate unit, release of ownership in a real estate unit, swap of ownership in a real estate unit and editing a social equity rating.

According to an embodiment of the present invention, the method further comprises the steps of: identifying one or more secondary users associated with said social contract; transmitting a vote request to each of said one or more secondary users, wherein said vote request is associated with said trigger event; receiving one or more responses from said one or more secondary users; and generating said social equity action, based at least in part on said one or more responses from said one or more users.

According to an embodiment of the present invention, the social contract is a housing club constitution, wherein said housing club constitution comprises information associated with one or more rules placed on a real estate unit, wherein said real estate unit has at least two owners.

According to an embodiment of the present invention, the method further comprises the steps of: receiving an update request from one or more of said one or more users, wherein said update request is associated with a request to change one or more social contract parameters in said final set of social contract parameters; identifying one or more secondary users associated with said social contract, wherein said one or more secondary users are at least partial owners of said real estate unit; transmitting a vote request to each of said one or more secondary users, wherein said vote request is associated with said update request; receiving one or more responses from said one or more secondary users; generating an update to said social contract, based at least in part on said one or more responses from said one or more users, wherein one or more social contract parameters in said final set of social contract parameters is changed; and recording said update to said social contract.

According to an embodiment of the present invention, a computerized system for providing automated social contracts, said computerized system comprising: a social equity module, comprising computer-executable code stored in non-volatile memory; a processor; and one or more communications means; wherein the social equity module, the processor, and the one or more communications means are configured to: receive a social contract generation request; identify one or more users associated with said social contract generation request; identify a first set of social contract parameters from said social contract generation request; identify a second set of social contract parameters from said one or more users; determine compatibility between said first set of social contract parameters and said second set of social contract parameters; generate a final set of social contract parameters, wherein said final set of social contract parameters are based at least in part on said first set of social contract parameters and said second set of social contract parameters; determine one or more trigger events for one or more social contract parameters in said final set of social contract parameters, wherein said trigger events generate social contract, wherein said social contract; and generate a social contract based at least in part on said final set of contract parameters and said one or more trigger events.

According to an embodiment of the present invention, the social equity module, the processor, and the one or more communications means are further configured to: transmit said social contract to said one or more users; receive, from said users, an executed version of said social contract; and record said social contract.

According to an embodiment of the present invention, the social equity module, the processor, and the one or more communications means are further configured to: receive a trigger alert associated with said social contract; identify a trigger event from said one or more trigger events, wherein said trigger event is associated with said trigger alert; and execute a social equity action in response to said trigger event.

According to an embodiment of the present invention, the social equity module, the processor, and the one or more communications means are further configured to: identify one or more secondary users associated with said social contract; transmit a vote request to each of said one or more secondary users, wherein said vote request is associated with said trigger event; receive one or more responses from said one or more secondary users; and generate said social equity action, based at least in part on said one or more responses from said one or more users.

According to an embodiment of the present invention, the social equity module, the processor, and the one or more communications means are further configured to: receive an update request from one or more of said one or more users, wherein said update request is associated with a request to change one or more social contract parameters in said final set of social contract parameters; identify one or more secondary users associated with said social contract, wherein said one or more secondary users are at least partial owners of said real estate unit; transmit a vote request to each of said one or more secondary users, wherein said vote request is associated with said update request; receive one or more responses from said one or more secondary users; generate an update to said social contract, based at least in part on said one or more responses from said one or more users, wherein one or more social contract parameters in said final set of social contract parameters is changed; and record said update to said social contract.

Various objects, features, aspects and advantages of the disclosed subject matter will become more apparent from the following detailed description of embodiments, along with the accompanying drawing figures in which like numerals represent like components.

### BRIEF DESCRIPTION OF THE DRAWINGS

FIG. 1 is an illustration of a system for providing automated social contracts, in accordance with an embodiment of the present invention.

FIG. 2 is an illustration of a system for providing automated social contracts, in accordance with an embodiment of the present invention.

FIG. 3 is an exemplary embodiment of a method for providing automated social contracts.

FIG. 4 is an exemplary embodiment of a method for providing automated social contracts.

### DETAILED DESCRIPTION

The present disclosure relates to methods and systems for providing automated social contracts. More specifically embodiments of the present invention are directed to a computerized system and method for providing users of the system to enter into automated self-effecting contracts. Preferred embodiments of the present invention are directed to providing self-effecting social contracts for the management and maintenance of arrangements between individuals sharing a single real estate unit.

Preferred embodiments of the present invention are partially directed at updating meeting the demands for “care free” management and extreme mobility of younger generations. Embodiments of the present invention are directed in part to enable creation of a new type of residential “HOME OWNER MOBILITY” which is more suited to younger generations of individuals. While the system and methods herein are immediately and highly useful to younger generations of individuals, it is also applicable, valuable and useful to other generations as well. As an example, older adults who prefer like-minded companionship after their children have left home or their marriage has dissolved due to separation, divorce or death of a partner.

According to an embodiment of the present invention, the system enables social management via social frameworking and a rewards and penalties gradient ethical system between users/customers (“Members”). In certain embodiments, the system is configured to automate and process legal and financial management of real estate units shared by multiple individuals.

According to an embodiment of the present invention, while moving around within specified rules, the system gives members the ability to accumulate social and financial equity while living within the parameters of smart/social contracts agreed upon by individuals and automatically implemented and administered by the system. Advantageously, the system is capable of allowing for social arrangements to be maintained without need for extra-personnel or judicial intervention in order to adjudicate the issues or actions associated with such smart contracts.

In a preferred embodiment, a semi-open (permission) distributed ledger technology (DLT) system is utilized to intelligently manage and execute on such smart contracts via the use of certain smart algorithms and to process and effect the implementation of such smart contracts. In this manner, the system may be configured to automate the execution and management of such social based smart contracts. The system may leverage the DLT system or other distributed ledger (e.g., blockchain exchange) to record these transactions.

According to a preferred embodiment of the present invention, the computerized systems utilized to enable the methodologies detailed herein are cloud based and managed, with certain components being preferably implemented in distributed means, such as the smart contracts which would use distributed ledger means. In other embodiments, the system may also leverage users and communities of users to assist with the management functions of the system through input and interaction with the system.

In a preferred embodiment, a core of the system utilizes a distributed ledger component (e.g., DLT, blockchain), “automated social frameworking” and a social equity system and network to ensure certain behavioral and social aspects of multi-tenant living is upheld and maintained.

The system in the preferred embodiment supports partial or fractional ownership of real estate units where membership in the underlying real estate unit is subject to terms of a social contract/social agreement amongst its members, referred to herein as a Housing Club Constitution. The Housing Club Constitution, and other associated house rules, obligations and social incentivization programs form the social frameworking aspect that allows, at least in part, for the social management provided by the system. Via the system, these private housing club(s) allow members to create a set of by-laws for fractionally owned real estate units which allows for members to be in control over whom they wish to associate with in their real estate units and how rules are administered for living in such shared real estate unit. This may be ownership via title or deed, or “beneficial ownership” as detailed below. Such private housing clubs assist in providing housing for members and wherein membership acceptance criteria is used to create a group of people who become party to an Housing Club Constitution. Such a private housing club may offer and administer member benefits, rules, rewards, and penalties and may offer activities, social or career introductions, education, arbitrations, and/or other perks. A Housing Club Constitution may require members to honor the location specific “House Rules” agreed upon by the residents of a particular apartment or house and also calls for the reward of certain agreed upon positive behavior and likewise the penalization of negative behavior. Automation of the execution such rewards and penalties associated with a Housing Club Constitution may be implemented, for instance, via smart contract or other computer implemented and regulated means provided by the system. Altering or amending of the House Rules generally would require altering a Housing Club Constitution. The system may provide various means for altering the House Rules, such as via a unanimous vote of members to the Housing Club Constitution to change local social frameworking of the underyling real estate unit associated with the Housing Club Constitution. Other changes to the House Rules may occur when they are “measured” ahead of time or otherwise approved by a broader or regional social community via committee. In each case, the changes are only recorded to the Housing Club Constitution if approved appropriately, and recorded to the Housing Club Constitution (e.g., via utilization of the DLT).

In certain embodiments, a Housing Club Constitution may be implemented which limits or sets forth preferred requirements for a member to join in fractional ownership of a particular real estate unit. Again, as above, this may be ownership via title or deed, or “beneficial ownership” as detailed below. An example case for this is the fractional ownership of a multi-bedroom unit, wherein each member will be obtaining fractional ownership in the real estate unit, wherein the fractional ownership is associated with a particular bedroom within the multi-bedroom unit. Given, in this example case, there will be multiple members sharing the common areas (e.g., bathrooms, kitchen, living room) of a multi-bedroom unit, it is desirable to have a set of rules that are commonly acceptable to the members. While the Housing Club Constitution may include certain objective rules that should be complied with, such as not leaving dishes in a sink, not smoking indoors, not having one or more forms of pets, or not having more than a certain number of overnight guests at a time, the system may be configured to allow the members to set subjective standards in the Housing Club Constitution as well.

In certain embodiments, the system employs a networked ownership platform. The networked ownership platform is configured to manage and oversee, in part, a distributed yet cooperating network of individual legal entities which are trusts or trust-like entities to hold legal title to real properties and reserve much of the beneficial title for the benefit of the members who are legally limited beneficiaries in these entities (and therefore or otherwise known as “beneficial owners” in such entities and have “beneficial ownership” in one or more of the underlying real estate units). In certain embodiments, a network or networks of trustees or managers led by a common trust services company or alternatively a network of decentralized cooperating trustees or managers utilize the system, which provides cloud management and artificial intelligence to provide services to value, maintain, or improve real properties with the focus of accreting greater value over time and assists in the enforcement of the agreed upon rules of a Housing Club Constitution when it comes to fees, fines, and occupancy rights of resident club members. These trustees or managers of individual real properties may contractually cooperate with each other in supporting resident owner swaps and management as such activity comports to both an agreed upon housing club constitution and to individual resident House Rules. While a preferred embodiment may leverage trusts and other such entities, one of ordinary skill in the art would appreciate that there are numerous corporate or other legal entities that could be utilized with embodiments of the present invention, and embodiments of the present invention are contemplated for use with any appropriate legal structure.

For clarity, when discussing ownership, or beneficial ownership, herein with respect to ownership provided to users, in preferred embodiments, the ownership or beneficial ownership change is not a change in the ownership of the property via transfer of deed or title in the property, but rather change in ownership of a legal entity or a recorded ownership in the form of tokenized ownership (e.g., recording ownership on a DLT system). However, in certain embodiments, such as where laws may require it, a change in the title, deed or other legal construct associated with the real estate unit may be transferred and recorded.

In preferred embodiments, where tokenized ownership is recorded via a DLT system, tokens may be comprised of data identifying fractional ownership of one or more real estate units. The data in these tokens may also comprise data associated with beneficial rights associated with the real estate unit and the user, such as residential rights and pro-rata equity rights. Residential rights may include, but are not limited to sub-rights permissible under a smart contract (e.g., Housing Club Constitution), such as visitor rights, sublet rights, and other similar rights associated with the real estate unit. Pro-rata equity rights detail the portion of the real estate unit that a user associated with the token has equity in. The pro-rata equity right in any token increases as payments are made to the system overtime. Eventually, when fully paid, the pro-rata equity right in a token will equal 100% of the available equity in the token.

Further, the system may be configured to allow for the House Club Constitution to have elements for setting requirements, criteria or suggestions for allowing new members to enter into the Housing Club Constitution (e.g., replace an existing member with a new member). For instance, the system may allow for the Housing Club Constitution to identify certain restrictions, criteria, preferences or suggestions on potential member's characteristics (e.g., gender, nationality, religion), traits (e.g., cleanliness, honesty, openness, cultural, language, tastes in music, computer gaming, sports, fashion, hobbies, desire for diversity, political views, or different other user-defined “affinity groups”), or other objective or subjective data point in order to ensure the members of a private housing club to maintain a particular desired atmosphere for a real estate unit.

According to an embodiment of the present invention, the system may be further configured to process sale of member real property on the network under certain conditions including market conditions, zoning or eminent domain requirements, or financing opportunities to return maximum degree of capital to members based upon social equity or social equity trustee.

In conjunction with the aforementioned usage of the Housing Club Constitution, the system may be configured to utilize training models and predictive analytics to identify to members and potential members matches for real estate units that suit their own characteristics and the characteristics of real estate units to determine whether a particular member would be a good fit for a particular real estate unit. As the system has access to data points from both the member and the real estate unit, and will have an ever-increasing number of data points related to how relationships transpired (e.g., good, bad, neutral) between and amongst members, Housing Club Constitutions and/or real estate units. Ultimately, when the system has enough data points at its disposal, the system will be extremely accurate at identifying potentially sublime matches between members and real estate units.

In a preferred embodiment, “Social Frameworks”, of which the House Club Constitution is one, are further supported and provided by the system in a networked structure. Ratings of individual members/users (i.e., Social ratings), financial rewards (which may be implemented in cryptocurrency and/or fiat currency) and financial fines (which may be implemented cryptocurrency and/or fiat currency) may be administered based upon social behavior, ratings, and on time or late payments—as prescribed in the House Club Constitution.

In a preferred embodiment of the present invention, the social rewards component and social equity payment component of the system enable the payment of currency (e.g., fiat, crypto) to or by a member, regardless of any country in which the member is in, and may guarantee that the price of the currency is pegged to the national fiat currency in which the member is situated without added financial risk to either the member or the system.

The system, in at least one preferred embodiment, utilizes cloud management and AI to manage the member experience in a decentralized social housing club (or group operating with or within one or more social frameworks) across a geographically decentralized physical network, wherein residential, cultural, and certain financial information is made available to participants who join the network.

According to an embodiment of the present invention, with respect to the House Club Constitution, or other social contracts, the system may be configured to use the parameters of the contract to provide for an alternative dispute resolution means for users to adjudicate their differences and breaches of the social contract. For instance, the system may set into place a series of automated steps for identifying, reporting, adjudicating and implementing resolutions associated with a social contract. In adjudicating the social contract, the system may leverage both objective data and subjective data provided to the system in order to process an appropriate outcome for the resolution. Objective data may include, but is not limited to, data received from a security system (e.g., door open/close sensor data, security camera data, smoke detector data), data received from other users (e.g., photographic data, audio data), financial data (e.g., late payments), or any combination thereof. Subjective data may include data points such as unverifiable data from users (e.g., impressions of another user about their traits or qualities). One of ordinary skill in the art would appreciate that there are numerous objective and subjective data points that could be used with embodiments of the present invention, and embodiments of the present invention are contemplated for use with any appropriate data points.

In preferred embodiments of the present invention, the system is not only configured to penalize, tax or otherwise influence users through actions taken on their missteps, but also reward users for their compliance with the social contract(s) and economic responsibilities. In particular, preferred embodiments of the present invention provide a system whereby social equity and ranking/rating is developed by users for compliance with social contracts they enter into. Social equity rewards may include, but are not limited to, financial rewards, relationship awards (e.g., makes available better or highly desirable properties to those with high social equity ratings), invitation to private events, social introductions, career introductions, “perks such as discounts on products or services, or other personal benefits (e.g., discounts for healthcare or other services) or any combination thereof. One of ordinary skill in the art would appreciate that there are numerous types of social equity rewards that could be utilized with embodiments of the present invention, and embodiments of the present invention are contemplated for use with any appropriate social equity rewards.

While descriptions of embodiments of the present invention detailed herein are directed primarily at residential units, one of ordinary skill in the art would appreciate that the systems and methods detailed herein would be similarly applicable to commercial or industrial real estate as well. For instance, as an alternative to purchasing or renting commercial or industrial real estate units, users may engage the system for commercial real estate ownership mobility or industrial real estate ownership mobility, where instead of mobility of housing units or fractions thereof, the mobility is of commercial or industrial units, or logical fractions thereof.

Similarly, in embodiments of the present invention implemented for commercial or industrial real estate, the smart contracts could enforce both social and economic terms on any commercial or industrial unit. For instance, a commercial club contract could be used to put into place rules for a commercial real estate unit, such as what types of tenants may occupy the space (e.g., no competing businesses, no businesses of a certain type), what tenants obligations are (e.g., snow removal, garbage removal, hours of operation), what tenants restrictions are (e.g., curb/frontage usage/restrictions, limitations on use as a residence), or any combination thereof. One of ordinary skill in the art would appreciate that there are numerous rules/restrictions that could be put into place on commercial or industrial real estate units via these smart contracts, and embodiments of the present invention are contemplated for use with any appropriate rules/restrictions.

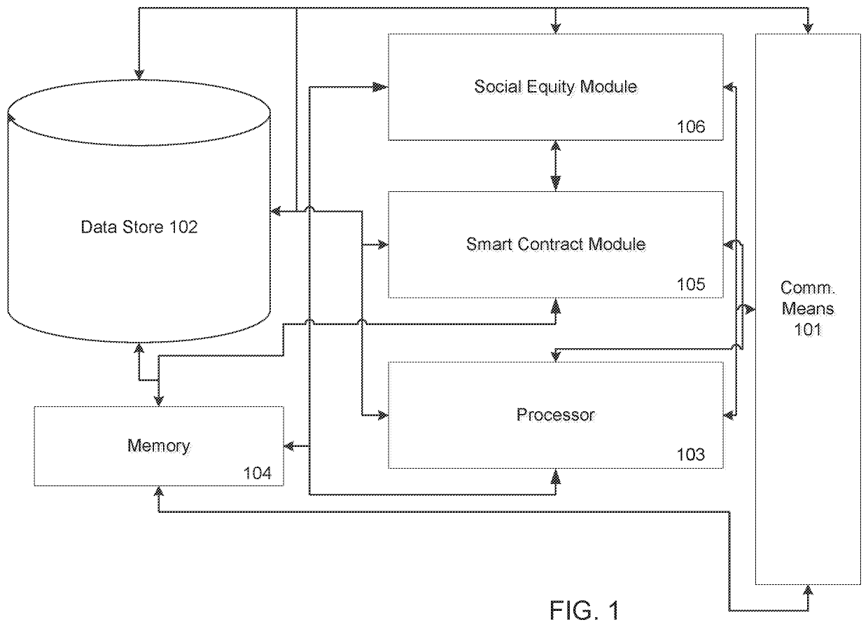

Turning now to FIG. 1, an exemplary system for providing automated social contracts is shown, in accordance with an embodiment of the present invention. The system comprises: one or more communications means, such as circuitry for wireless communications, circuitry for wired communications, circuitry for voice or data communications, or any other communications systems; one or more data stores 102, such as a database, file repository system, or other non-transitory storage medium; one or more processors 103, such as a central processing unit (CPU) or other specialized processing device; one or more memory devices 104, such as RAM, ROM, cache or other memory system; a smart contract module 105; and a social equity module 106.

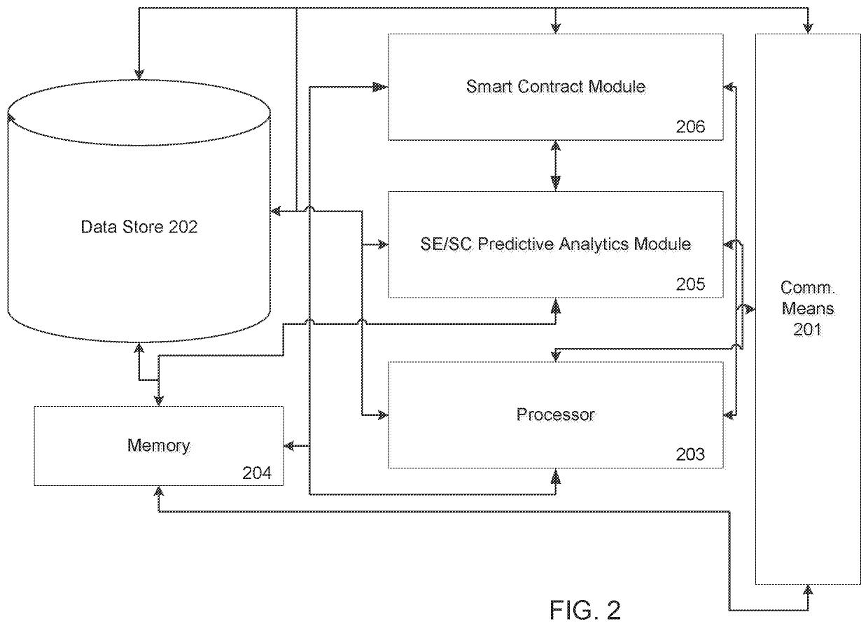

Turning now to FIG. 2, an exemplary system for providing automated social contracts is shown, in accordance with an embodiment of the present invention. The system comprises: one or more communications means, such as circuitry for wireless communications, circuitry for wired communications, circuitry for voice or data communications, or any other communications systems; one or more data stores 202, such as a database, file repository system, or other non-transitory storage medium; one or more processors 203, such as a central processing unit (CPU) or other specialized processing device; one or more memory devices 204, such as RAM, ROM, cache or other memory system; a social equity and smart contract predictive analytics module 205; and a smart contract module 206.

The embodiments shown in FIGS. 1 and 2 are merely exemplary embodiments of the present invention, and one of ordinary skill in the art would appreciate that the configurations could be adapted to use additional or fewer components, or otherwise combined or modified to provide the systems and methods detailed herein. As such, each of these modified embodiments are contemplated for use with the system and methods described herein.

Further, one of ordinary skill in the art would appreciate that the system could be implemented in a variety of manners, such as locally on a computing device (e.g., smartphone), managed via a remote or distributed system and provided as a service (e.g., SaaS) layer between a contact and receiving elements of the user, or some combination thereof. As such, each of these implementations are contemplated for use with the system and methods described herein.

According to an embodiment of the present invention, the system may comprise one or more modules integrated or stored on a computer readable medium, or otherwise be accessible to a processor for instructing the processor to take various actions inline with the methods described herein. Modules may include, but are not limited to, a smart contract module 105, a social equity module 106, a social equity/smart contract (SE/SC) predictive analytics module 205 or any combination thereof. One of ordinary skill in the art would appreciate that these modules could be implemented in various manners, and combined or further broken down into additional modules, depending on the architecture and implementation of the system.

According to an embodiment of the present invention, a smart contract module 105 is configured to provide the system the ability to identify, process and record transactions associated with smart contracts managed by the system, wherein the transactions are between users of the system. The transactions may include, but are not limited to: generation of a smart contract (e.g., housing club contract); formation of a social contract; updates to smart contracts; termination of smart contracts; administration of smart contracts (e.g., updating terms, updating owners); effecting the automatic enforcement of terms in the smart contracts (e.g., trigger events that effect an automatic transaction associated with a user); administration of social rankings or ratings of various users; recordation of social transactions; and any combination thereof. In preferred embodiments, the smart contract module is configured to handle processing and recording of the social and contractual aspects of the methods detailed herein. In these preferred embodiments, the smart contract module leverages distributed ledgers to affect and record the actions conducted and transacted by the social equity module.

According to an embodiment of the present invention, a social equity module 106 is configured to provide social equity management, tracking and rating/ranking abilities to the system. The social equity module leverages information available and associated with various users to generate ranking and ratings of users, based on parameters and criteria known about the users. Particularly, the social equity module is used to determine characteristics of the users for various purposes, such as determining whether a set of users would be compatible tenants in the same real estate unit, based on criteria know about the users (e.g., social rankings/ratings, self-provided details, details provided by other users, demographics).

According to an embodiment of the present invention, a social equity/smart contract (SE/SC) predictive analytics module 205 is configured to work in conjunction with the smart contract module and the social equity module in order to provide high quality matches and advice to users. In preferred embodiments, the SE/SC predictive analytics module may leverage predictive analytic and artificial intelligence means to make determinations based on past experiences and matches presented to the system. Advantageously, in this configuration, the system is able to provide advanced features, such as: providing automated advice on topics such as what parameters to include in a smart contract; providing insight into whether users would likely be good roommates/housemates/flatmates that have a high probability of being successful in the long term; and providing insight as to whether particular users are likely to breach or otherwise have issues with certain terms in a smart contract—even before the smart contract is executed.

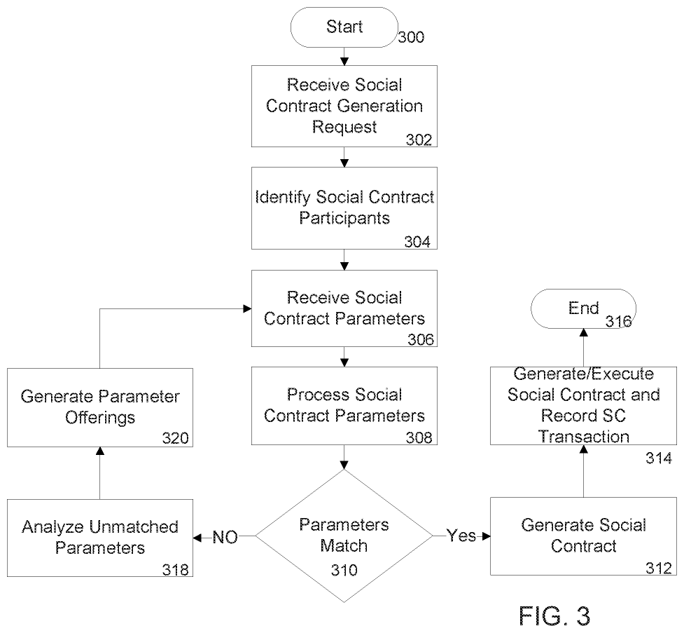

Turning now to FIG. 3, an exemplary method for generating a social contract, in accordance with an embodiment of the present invention, is shown. The process starts at step 300 with the system being engaged to generate a social contract. At step 302, the system receives a social contract generation request. The social contract generation request is generally a request from one or more users to have a social contract generated based on certain parameters. In some embodiments, the system may be utilized to help identify or provide appropriate parameters for the social contract.

At step 304, the system processes the social contract generation request and identifies the participants to the social contract. The participants are generally one or more users of the system, but in some cases the system may provide for utilization and generation of a social contract to a non-user (or otherwise invite non-users to become users for the purpose of entering into and engaging in a social contract with current users).

At step 306, the system receives social contract parameters. The social contract parameters are received from one or more of the social contract generation request, information stored with the system and associated with one or more of the participants (e.g., social rating, preferences, criteria, demographics), information accessible by the system from third party sources (e.g., social media).

At step 308, the system processes the social contract parameters to ensure that they are compatible and match various criteria associated with the participants. For instance, the system may be configured to ensure that a social contract is not generated where the participants would have an inherent conflict, such as a housing club constitution that was proposed with participants of differing genders, where one or more participants have criteria associated with them indicating they would only want to join a housing club constitution where all participants are of the same gender. In certain embodiments, the system may further leverage the SE/SC predictive analytics module and the methods associated with it to identify social contract parameters and criteria that would not have a high probability of success in the long term and indicate this to the users.

If the social contract parameters do not match or otherwise appear to be incompatible, the system will analyze the unmatched parameters. Using artificial intelligence and training data, the system can analyze the conflicting parameters presented for use in the generation of a social contract (step 318). The system will then use this analysis to generate parameter offerings for presentation to the participants in order to help find potential common ground on unmatched items (step 320)—at which point the system will provide the options to the participants/users and return to step 306.

If the parameters match, the system will proceed to generate the social contract (step 312) with the various terms and actionable items for each social contract parameter. In preferred embodiments, the social contracts will be generated and effected with triggers that occur when one or more parameters are met or breached. In this manner, these smart contracts are automatically self-effecting, and prevent the need to have external adjudication (e.g., courts) to resolve conflicts.

The social contract generated at step 312 is then sent to the participants for execution. At step 314, the system receives the executed version (e.g., electronically signed, scanned copies) and the system will complete the execution and recordation of the social contract. At this point, the process terminates at step 316.

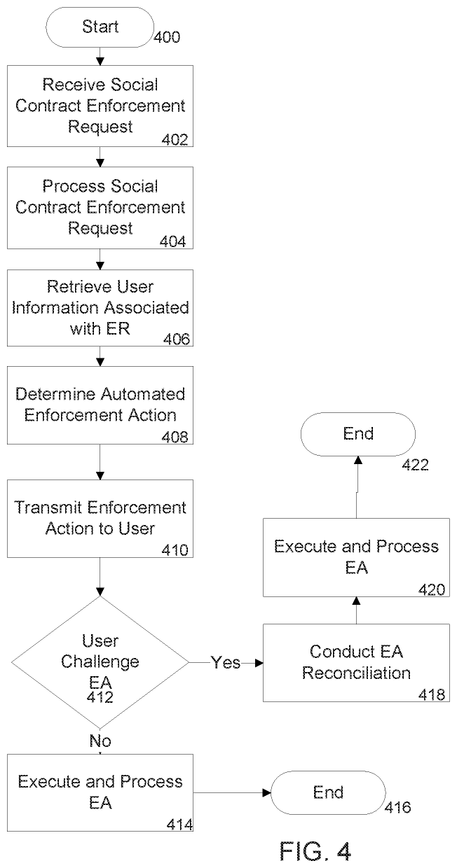

Turning now to FIG. 4, an exemplary method for the enforcement of a social contract, in accordance with an embodiment of the present invention, is shown. At step 400, the process starts with the system being engaged to automatically enforce a social contract. At step 402, the system receives a social contract enforcement request. Generally, this would be from a participant to the social contract, particularly as it may relate to a breach of the social contract by another participant.

At step 404, the system processes the social contract enforcement request, extracting the information and data contained therein. In general, the social contract enforcement request may comprise, but is not limited to, identification of the social contract associated with the request, identification of the provision in the social contract that is to be enforced, information associated with or required to identify the participants involved in the enforcement request, any information or data to support or assist with the validation of the enforcement request, or any combination thereof.

At step 406, the system retrieves user information associated with the participants involved in the enforcement request. This information may be related to the participant bringing the enforcement request, or the participant that has the enforcement request lodged against them.

At step 408, the system retrieves the social contract identified in the enforcement request (or a portion thereof) and determines the triggered enforcement action (e.g., financial penalty, termination of social contract, termination of ownership in real estate unit ownership). The system then generates and transmits the enforcement action to the participant in the social contract to whom the enforcement request was lodged against. This is to give such a participant the opportunity to contest the enforcement action.

If the enforcement action is not contested, the system executes the enforcement action and processes the triggered enforcement action (step 414). At this point the process would terminate at step 416.

Otherwise, if the enforcement action is contested, the system engages in an enforcement action reconciliation at step 418. In certain embodiments, the enforcement action reconciliation may be fully automated and the system can review objective data to make a determination on the enforcement action. For instance, if the social contract has a provision whereby the participants have agreed that no participant should have members of the opposite gender overnight in the real estate unit associated with the social contract, the system could leverage data provided from an associated security system (e.g., door sensors, cameras) to confirm a breach of this provision and automatically enforce the agreed penalties for such breach. In other embodiments, external intervention can be leveraged as well, such as via an arbitrator who can verify subjective or other non-definitive objective data.

At step 420, the system processes the enforcement action, whether overcome by the participant challenging the enforcement action, or maintaining the enforcement action as-is, in light of the data utilized by the system to confirm the enforcement action. After executing the enforcement action in such a manner, the process terminates at step 422.

Throughout this disclosure, numerous references are made to servers, services, interfaces, engines, modules, clients, peers, portals, platforms, or other systems formed from computing devices. It should be appreciated that the use of such terms is deemed to represent one or more computing devices having comprising one or more processors (e.g., ASIC, FPGA, DSP, x86, ARM, ColdFire, GPU, multi-core processors) configured to execute software instructions stored on a computer readable tangible, non-transitory medium (e.g., hard drive, solid state drive, RAM, flash, ROM, etc.). For example, a server can include one or more computers operating as a web server, database server, or other type of computer server in a manner to fulfill described roles, responsibilities, or functions.

One of ordinary skill in the art would further appreciate the disclosed computer-based algorithms, processes, methods, or other types of instruction sets can be embodied as a computer program product comprising a non-transitory, tangible computer readable media storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, a circuit-switched network, the Internet, LAN, WAN, VPN, or other type of network. The terms “configured to” and “programmed to” in the context of a processor refer to being programmed by a set of software instructions to perform a function or set of functions.

While the inventive subject matter is susceptible of various modification and alternative embodiments, certain illustrated embodiments thereof are shown in the drawings and will be described below in detail. It should be understood, however, that there is no intention to limit the invention to the specific form disclosed, but on the contrary, the invention is to cover all modifications, alternative embodiments, and equivalents falling within the scope of the claims.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

In some embodiments, the numbers expressing quantities or ranges, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements. Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified, thus fulfilling the written description of all Markush groups used in the appended claims.

What is claimed is:

1. A computerized method for providing automated social contracts, said computerized method using a social equity module, a processor and a communication means, the method comprising the steps of:
receiving a social contract generation request;
identifying one or more users associated with said social contract generation request;
identifying a first set of social contract parameters from said social contract generation request;
identifying a second set of social contract parameters from said one or more users;
determining compatibility between said first set of social contract parameters and said second set of social contract parameters;
generating a final set of social contract parameters, wherein said final set of social contract parameters are based at least in part on said first set of social contract parameters and said second set of social contract parameters;
determining one or more trigger events for one or more social contract parameters in said final set of social contract parameters, wherein said trigger events generate social contract, wherein said social contract; and
generating a social contract based at least in part on said final set of contract parameters and said one or more trigger events.

2. The method of claim 1, further comprising the steps of:
transmitting said social contract to said one or more users;
receiving, from said users, an executed version of said social contract; and
recording said social contract.

3. The method of claim 2, wherein said social contract is recorded using a distributed ledger technology.

4. The method of claim 1, further comprising the steps of:
receiving a trigger alert associated with said social contract;
identifying a trigger event from said one or more trigger events, wherein said trigger event is associated with said trigger alert; and
executing a social equity action in response to said trigger event.

5. The method of claim 4, wherein the social equity action is selected from the group comprising financial transactions, termination in ownership of a real estate unit, change in equity in a real estate unit, release of ownership in a real estate unit, swap of ownership in a real estate unit and editing a social equity rating.

6. The method of claim 4, further comprising the steps of:
identifying one or more secondary users associated with said social contract;
transmitting a vote request to each of said one or more secondary users, wherein said vote request is associated with said trigger event;
receiving one or more responses from said one or more secondary users; and
generating said social equity action, based at least in part on said one or more responses from said one or more users.

7. The method of claim 1, wherein said social contract is a housing club constitution, wherein said housing club constitution comprises information associated with one or more rules placed on a real estate unit, wherein said real estate unit has at least two owners.

8. The method of claim 7, further comprising the steps of:
receiving an update request from one or more of said one or more users, wherein said update request is associated with a request to change one or more social contract parameters in said final set of social contract parameters;
identifying one or more secondary users associated with said social contract, wherein said one or more secondary users are at least partial owners of said real estate unit;
transmitting a vote request to each of said one or more secondary users, wherein said vote request is associated with said update request;
receiving one or more responses from said one or more secondary users;
generating an update to said social contract, based at least in part on said one or more responses from said one or more users, wherein one or more social contract parameters in said final set of social contract parameters is changed; and
recording said update to said social contract.

9. A computerized system for providing automated social contracts, said computerized system comprising:
a social equity module, comprising computer-executable code stored in non-volatile memory;
a processor; and
one or more communications means;
wherein the social equity module, the processor, and the one or more communications means are configured to:
receive a social contract generation request;
identify one or more users associated with said social contract generation request;
identify a first set of social contract parameters from said social contract generation request;
identify a second set of social contract parameters from said one or more users;
determine compatibility between said first set of social contract parameters and said second set of social contract parameters;
generate a final set of social contract parameters, wherein said final set of social contract parameters are based at least in part on said first set of social contract parameters and said second set of social contract parameters;
determine one or more trigger events for one or more social contract parameters in said final set of social contract parameters, wherein said trigger events generate social contract, wherein said social contract; and
generate a social contract based at least in part on said final set of contract parameters and said one or more trigger events.

10. The system of claim 9, wherein the social equity module, the processor, and the one or more communications means are further configured to:
transmit said social contract to said one or more users;
receive, from said users, an executed version of said social contract; and
record said social contract.

11. The method of claim 10, wherein said social contract is recorded using a distributed ledger technology.

12. The system of claim 9, wherein the social equity module, the processor, and the one or more communications means are further configured to:
receive a trigger alert associated with said social contract;
identify a trigger event from said one or more trigger events, wherein said trigger event is associated with said trigger alert; and
execute a social equity action in response to said trigger event.

13. The method of claim 12, wherein the social equity action is selected from the group comprising financial transactions, termination in ownership of a real estate unit, change in equity in a real estate unit, release of ownership in a real estate unit, swap of ownership in a real estate unit and editing a social equity rating.

14. The method of claim 12, wherein the social equity module, the processor, and the one or more communications means are further configured to:
identify one or more secondary users associated with said social contract;
transmit a vote request to each of said one or more secondary users, wherein said vote request is associated with said trigger event;
receive one or more responses from said one or more secondary users;
generate said social equity action, based at least in part on said one or more responses from said one or more users.

15. The method of claim 9, wherein said social contract is a housing club constitution, wherein said housing club constitution comprises information associated with one or more rules placed on a real estate unit, wherein said real estate unit has at least two owners.

16. The method of claim 15, wherein the social equity module, the processor, and the one or more communications means are further configured to:
receive an update request from one or more of said one or more users, wherein said update request is associated with a request to change one or more social contract parameters in said final set of social contract parameters;
identify one or more secondary users associated with said social contract, wherein said one or more secondary users are at least partial owners of said real estate unit;
transmit a vote request to each of said one or more secondary users, wherein said vote request is associated with said update request;
receive one or more responses from said one or more secondary users;
generate an update to said social contract, based at least in part on said one or more responses from said one or more users, wherein one or more social contract parameters in said final set of social contract parameters is changed; and
record said update to said social contract.
